(19) United States
(12) Patent Application Publication
(10) Pub. No.: US 2026/0203938 A1
(43) Pub. Date: Jul. 16, 2026

(54) PROCESS AND SYSTEM FOR MINE EXCAVATION MONITORING

(71) Applicant: Orica International Pte Ltd, Singapore (SG)

(72) Inventors: Timothy William HUNT, Ontario (CA); Julian RAMIREZ RUISECO, Tie Siding, WY (US)

(21) Appl. No.: 19/135,773

(22) PCT Filed: Dec. 5, 2023
(86) PCT No.: PCT/SG2023/050808

§ 371 Date: Jun. 4, 2025

Related U.S. Application Data
(60) Provisional application No. 63/430,216, filed on Dec. 5, 2022.

(51) Int. Cl. G06T 7/73; E21C 41/00; E21F 17/18; G06T 7/62; G06T 17/05

(52) U.S. Cl. CPC G06T 7/75; E21C 41/00; E21F 17/18; G06T 7/62; G06T 17/05; E21C 2100/00; G06T 2207/30181

(57) ABSTRACT

A process for tracking material dislodged during blasting of a portion of a mine site, the process comprising: obtaining two or more volumetric models of the portion of the mine site over a period of time, wherein the volumetric metric models encompass a period during which the portion of the mine site is in operation, including at least a first point in time before at least one blast and a second point in time after at least one blast; and generating a 3D model by overlaying and merging the two or more volumetric models, wherein the model is representative of the portion of the mine site over the period of time.

### TECHNICAL FIELD

Aspects of the present disclosure relate to processing of volumetric models of a mine site, and more specifically to tracking of material dislodged during blasting, including processes, systems and computer-readable media configured therefor.

### BACKGROUND

During mining, a mine operator may use a process known as “reconciliation” to measure the effectiveness of the modelling, blasting, excavation and recovery processes, see e.g., Craig Morley & Heath Arvidson (“Mine value chain reconciliation—demonstrating value through best practice”, Tenth International Mining Geology Conference, 20-22 Sep. 2017). Reconciliation may use standard metrics referred to as F-Factors or F-Series metrics. F-factors may be used to reconcile, for example, the grade of mined minerals over a period, and be used to assign confidence to long term financial predictions based on long term models. This may be achieved by using an F1 factor which compares a long-term model with a short term in-situ model. An F2 factor can then be used to compare as-mined (short-term) minerals to the minerals that are produced from a mill or plant. An F3 factor, which involves a combination of the F1 factor and F2 factor, enables reconciliation to be determined, see e.g., Parker (“Reconciliation principles for the mining industry”, Transactions of the Institutions of Mining and Metallurgy: Section A, Volume 121, 2012-Issue 3, 2013).

The blasting processes are used to fragment and loosen geological material (e.g., rock, earth) with resources (e.g., ore) to allow excavation and recovery of the resources. In some blasting processes, it may be desirable to blast the rock in before excavation or interspersed with excavation. However, the movement of the geological material due the blasting processes may cause errors in existing processes of reconciliation, particularly when there are several stages of blasting (compound or repeated blasting).

Accordingly, there is a need for improved processes in reconciliation, including to calculate F factors more directly/accurately, to accommodate for interference introduced by blasting and compound blasting.

It is desired to address or ameliorate one or more disadvantages or limitations associated with the prior art, or to at least provide a useful alternative.

### SUMMARY

Disclosed herein is a process of tracking material dislodged during blasting of a (selected) portion of a mine site.

The process comprises:
a. obtaining two or more volumetric models of a (selected) portion of a mine site over a period of time, wherein the volumetric models encompass a period during which the portion of the mine site is in operation, including at least a first point in time before at least one blast and a second point in time after the at least one blast; and
b. generating a 3D model (“model in time”) by overlaying and merging the two or more volumetric models, wherein the model is representative of the portion of the mine site over the period of time.

The two or more volumetric models may include: an in-situ pre-blast topography model, and one or more post-blast topographies of the portion of the mine site after the at least one blast.

The one or more post-blast topographies may include two or more post-blast topographies after two or more respective blasts of the at least one blast.

The operation of the mine may include at least partial excavation of blasted materials after the at least one blast.

The process may include tagging excavation destinations and digging dates in the in-situ pre-blast topography model.

The process may include determining in-situ positions (in the in-situ pre-blast topography model) of selected nodes in the post-blast topographies based on received movement vectors for the at least one blast.

The process comprises:
a. encoding a (selected) portion of a mine site into two or more bounding volume hierarchy (BVH) nodes using a conversion engine (e.g., using a BVH CSG Engine);
b. receiving a first topography of the portion of the mine site (e.g., from LIDAR scanning) after at least one blast;
c. after at least partial excavation of the blasted material, marking the BVH nodes according to associated excavation destinations using fleet data or dig line data to determine the destinations for the BVH nodes;
d. receiving a second topography of the portion of the mine site after the partial excavation of the blasted material, and determining from the BVH nodes which of the BVH nodes are above the second topography, thus representing material excavated since the first topography was received;
e. determining in situ (before the at least one blast) positions of the BVH nodes based on received movement vectors for the at least one blast; and
f. receiving an in-situ pre-blast topography model; and
g. using the conversion engine and a Constructive Solid Geometry (CSG) process to tag excavation destinations and digging dates from the BVH nodes in the in-situ pre-blast topography model (which allows for any excavated volume of material, down to the bucket level, prior to the at least partial excavation, to be connected to in situ location of that volume of material, including small volumes (e.g., buckets) or large volumes (e.g., material that has been excavated over days/weeks/months/quarters/years)).

The process may include, using the tagged in-situ topography model:
a. receiving a user input from a user to select an area of interest and a date range of interest; and
b. applying the merged insituized topographies in the date range to the resource model and compare against known excavation destinations (including deliveries to plant) to generate a measurement of direct F3 reconciliation.

Disclosed herein is a system for tracking material dislodged during blasting of a portion of a mine site, the system including a computing system with a CPU and/or GPU configured to perform the process described above.

Disclosed herein is computer-readable media including machine-readable instructions that, when executed by a CPU and/or GPU, cause the CPU and/or GPU to perform the process described above.

### BRIEF DESCRIPTION OF THE DRAWINGS

Some embodiments of the present invention are hereinafter described, by way of example only, with reference to the accompanying drawings, wherein:

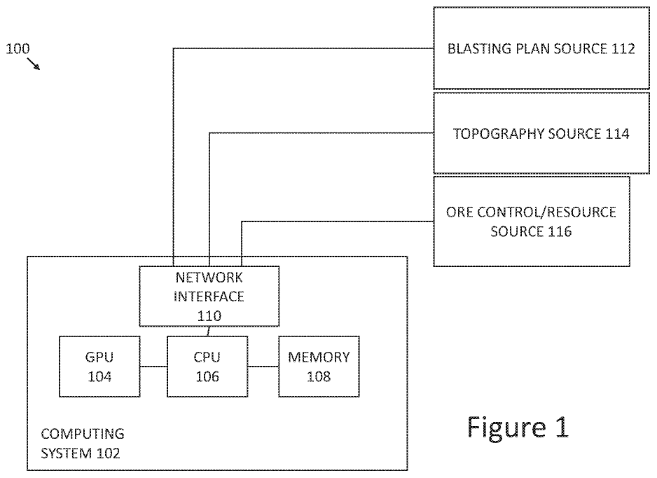

a. FIG. 1 is a block diagram of a system for mine excavation monitoring;

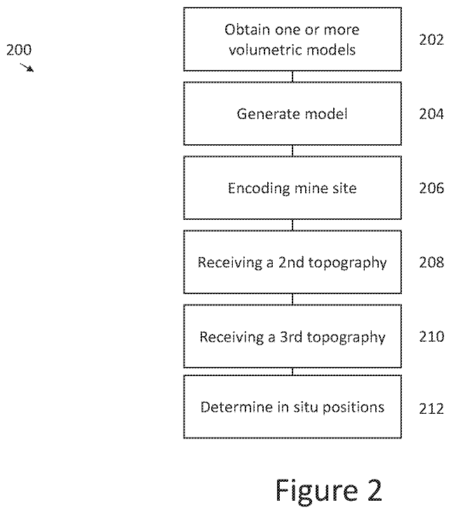

b. FIG. 2 is a flowchart of a process for mine excavation monitoring performed with the system, including determining in situ positions of minerals in a mine site;

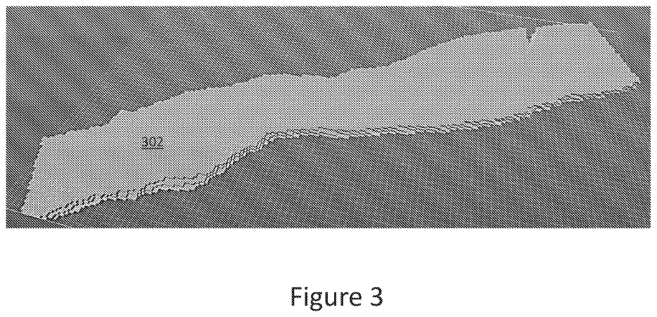

c. FIG. 3 is a screenshot depicting a first volumetric model of a selected portion of the mine site that is to be mined;

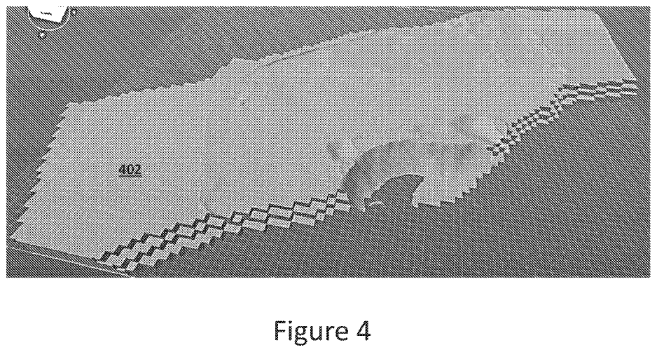

d. FIG. 4 is a screenshot depicting a 3D model comprised of the first volumetric model trimmed with the topography prior to blasting the first blast in the sequence;

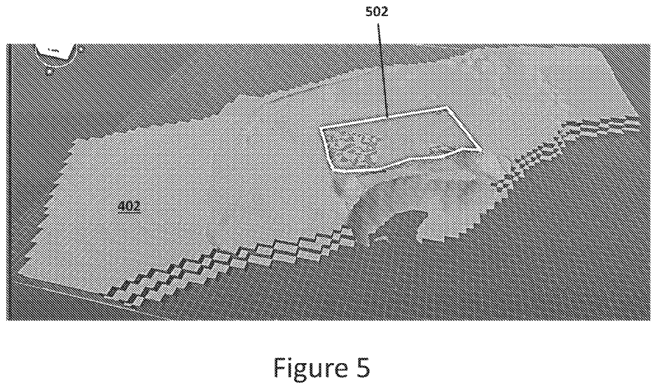

e. FIG. 5 is a screenshot depicting the 3D model and a first selected blasting location defined by a blasting plan on the pre-blast model of the portion of the mine site;

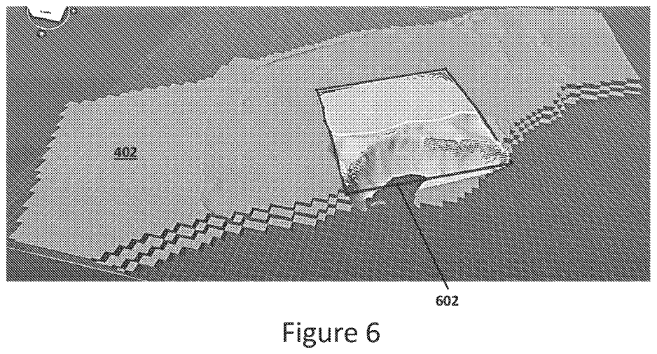

f. FIG. 6 is a screenshot depicting the 3D model and a first selected movable volume defined by a first blast in the blasting plan, capturing the entire volume which is expected to be affected by this blast;

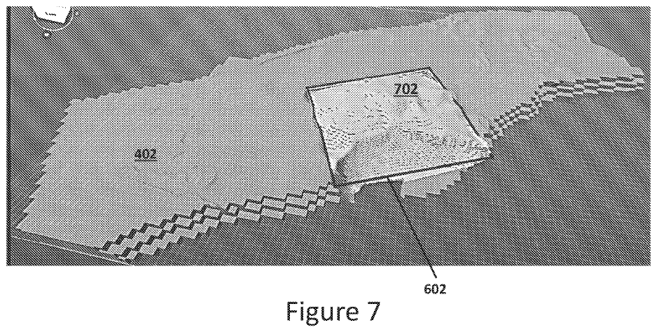

g. FIG. 7 is a screenshot depicting the 3D model and a first moved volume based on the first selected movable volume having been moved by the first blast;

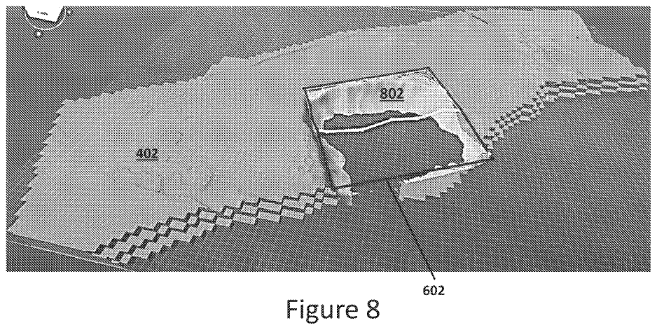

h. FIG. 8 is a screenshot depicting the 3D model and a first excavated volume;

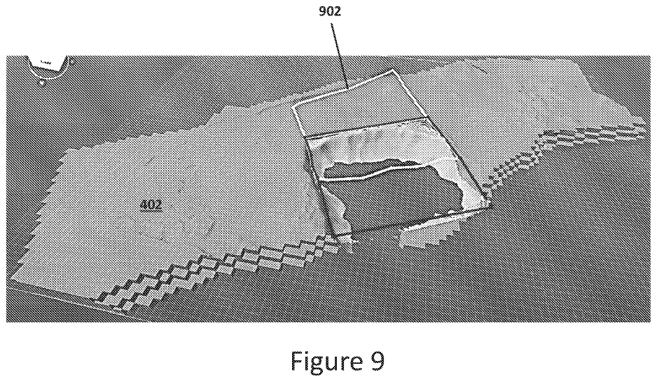

i. FIG. 9 is a screenshot depicting the 3D model, the first excavated volume, and a second selected blasting location defined by the blasting plan;

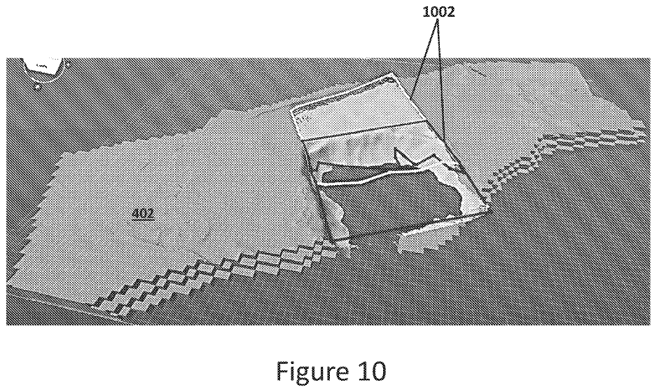

j. FIG. 10 is a screenshot depicting the 3D model and a second selected movable volume defined by a second blast in the blasting plan, including a second anticipated movement of rock;

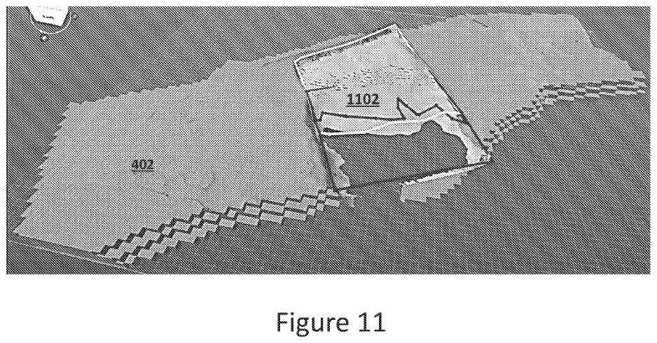

k. FIG. 11 is a screenshot depicting the 3D model and a second moved volume based on the second selected moving volume having been moved by the second blast;

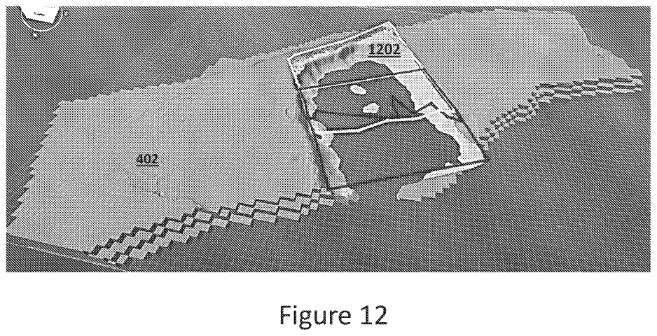

l. FIG. 12 is a screenshot depicting the 3D model and second excavated volume;

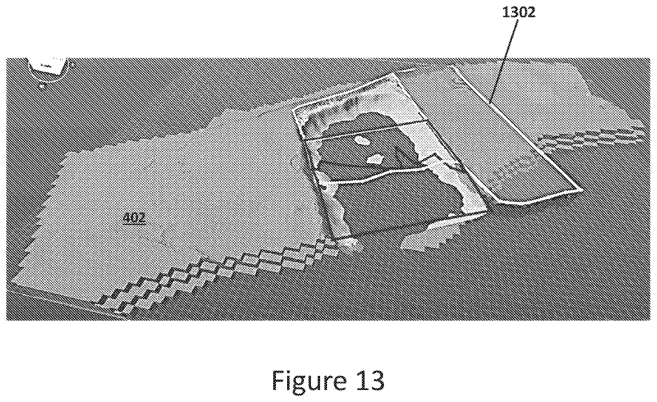

m. FIG. 13 is a screenshot depicting the 3D model, the second excavated volume, and a third selected blasting location defined by the blasting plan;

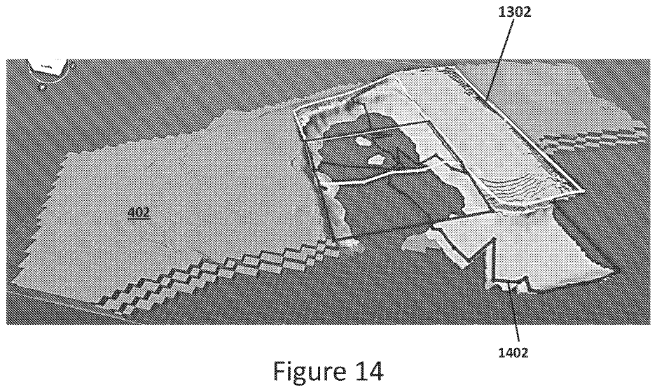

n. FIG. 14 is a screenshot depicting the 3D model and a third selected movable volume defined by a third blast in the blasting plan, including a third anticipated movement of rock; and

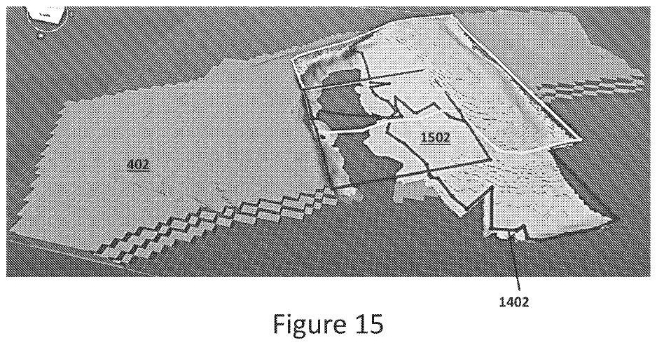

o. FIG. 15 is a screenshot depicting the 3D model and a third moved volume based on the third selected moving volume having been moved by the third blast.

### DETAILED DESCRIPTION

### Overview

The present disclosure relates to a system and process of connecting two or more three dimensional (3D) voxels in a post-blast digital model of a (selected) portion of a mine site to locations in a 3D pre-blast geological model of the portion of the mine site.

“Insituizing” refers to the act of taking information in post-blast space and finding the corresponding in-situ (pre-blast) position of the post-blast information. Insituizing may be primarily used for topographies to generate an equivalent in-situ volume where mining has occurred as described by the post-blast topography, e.g., to track where an excavated rock (which is excavated from a location modelled by a post-blast voxel) has come from in the pre-blast geology, which can be useful in determining the expected geological composition of excavated materials.

When a new topography is imported into the system, all material above this topography is marked as ‘mined’. The system can trace the mined material back through the mining process, using the system, to determine the pre blast positions of all of the mined material. The system and process can create an “insituized topography” by annotating the mined material with the percentage mined for each in situ block, and destination. Digging information and point measurement information can be tagged with specific post blast blocks, which can be “insituized” back to pre-blast space. The system and process can provide for near-instant reconciliation of any volume or post-blast data (as small as a single bucket) and all models that have ever occupied the same in-situ space.

Previous mine movement monitoring systems/processes may have tracked movement of geological material during blasting, e.g., using blast movement monitors, to estimate where the rocks from the pre-blast geology are located after blasting; however, such systems/processes did not allow for ore/rock tracking back to the in-situ model, particularly when a mine site was subjected to compound or repeated blasting. Although valuable material may be tracked by using blast movement monitors that are arranged to emit a detectable signal after blasting, the location of blast movement monitors must be carefully planned and manually set to specially accommodate each blast. Moreover, depending on the size of the blast, it is not uncommon for many small fragments to be created which may be undetectable by the blast markers and thus unaccounted for. As it is not uncommon for an area to be blasted multiple times, not only does it become increasingly tedious to plan and manually set blast markers after each blast, the number of undetected fragments also increases. Although it may be possible to construct a 3D model of a blast site from blast movement monitor measurements, such 3D models are based on volumetric measurements only, and thus the 3D model of the material to be excavated is characterized only by its volume, and volumetric measurements alone may be insufficient for high efficiency/accuracy as they cannot provide any estimation of grade or the geometallurgical information.

### System 100

As shown in FIG. 1, the system 100 disclosed herein may include:
a. a computing system 102, which includes at least a graphics processing unit 104, a central processing unit 106, at least one memory 108 (that is readable by the CPU 106 and GPU 104), and a network interface 110; and
b. data sources for the computing system 102, e.g., a source 112 of a blasting plan for the portion of the mine site, a source 114 of a topography of the portion of the mine site (e.g., a drone), and a 116 source of a resource model/ore control model of the portion of the mine site

The network interface 110 enables the CPU 106 and GPU 104 to construct volumetric models based on retrieving data from the data sources 112,114,116.

### Process 200

As shown in FIG. 2, the process 200 includes:
a. in a subprocess 202, the computing system 102 obtaining one or more volumetric models of the portion of the mine site, e.g., including first volumetric model 302 in FIG. 3, which may include a first topography of the portion of the mine site (obtained at a first point in time, before the first blast);
b. in a subprocess 204, the CPU 106 or GPU 104 trimming the first volumetric model 302 with the first topography, prior to blasting the first blast in the sequence, to generate a 3D model, e.g., 3D model 402 in FIG. 4, wherein the 3D model is representative of the portion of the mine site;
c. in a subprocess 206, the CPU 106 or GPU 104 encoding the 3D model 402 into two or more bounding volume hierarchy nodes using a conversion engine, which may be stored in memory 108;
d. the computing system 102 obtaining a first blasting location 502 from the blasting plan source 112 and adding it to the 3D model 402, e.g., as shown in FIG. 5;
e. in preparation for a first blast associated with the first blasting location 502, the CPU 106 defining a first selected movable volume 602, e.g., as shown in FIG. 6, that is defined by the first blast and captures the entire volume that is expected to be affected by this blast;
f. the CPU 106 or GPU 104 using the 3D model 402 to model the first moved volume 702 due to the first blast defined in the blasting plan, e.g., as shown in FIG. 7;
g. in a subprocess 208, after the first blast, the computing system 102 obtaining a second topography 802 of the portion of the mine site (obtained at a second point in time, after the first blast) to define an excavated volume, and overlaying and merging the second topography 802 to update the 3D model 402, e.g., as shown in FIG. 8;
h. the computing system 102 obtaining a second blasting location 902 from the blasting plan source 112 and adding it to the 3D model 402, e.g., as shown in FIG. 9;
i. in preparation for a second blast associated with the second blasting location 902, the CPU 106 defining a second selected movable volume 1002, e.g., as shown in FIG. 10, that is defined by the second blast and includes a second anticipated movement of the geological material;
j. the CPU 106 or GPU 104 using the updated 3D model 402 to model the second moved volume 1102 due to the second blast defined in the blasting plan, e.g., as shown in FIG. 11;
k. in a subprocess 210, after the second blast, the computing system 102 obtaining a third topography 1202 of the portion of the mine site (obtained at a third point in time after the second blast) to define a further excavated volume, and overlaying and merging the third topography 1202 to further update the 3D model 402, e.g., as shown in FIG. 12;
l . the computing system 102 obtaining a third blasting location 1202 from the blasting plan source 112 and adding it to the 3D model 402, e.g., as shown in FIG. 13;
m. in preparation for a third blast associated with the third blasting location 1302, the CPU 106 defining a third selected movable volume 1402, e.g., as shown in FIG. 14, that is defined by the third blast and includes a third anticipated movement of the geological material;
n. the CPU 106 or GPU 104 using the further updated 3D model 402 to model the third moved volume 1502 due to the second blast defined in the blasting plan, e.g., as shown in FIG. 15; and
o. in a subprocess 212, the CPU 106 or GPU 104 generating in situ positions of material from the excavated volumes, voxel by voxel, and thus with unprecedented accuracy.

The first volumetric model is representative of the portion of the mine site at the first point in time. The second volumetric model is representative of the portion of the mine site at the second point in time. Although not shown, it would be generally understood that several additional volumetric models may also be obtained at subsequent points in time.

By overlaying and merging the two or more volumetric models at the plurality of different points in time, a “model in time” can be generated.

The “model in time” can include data from the two or more sources 112,114,116. Individual layers are ranked based on the quality of the data, and layers that are considered to be a more accurate representative of the mine at a point in time may overwrite layers that are less accurate. For example, where both an ore control model and resource model layer exist, the resource model is overwritten even if the Resource Model is more recent. An ore control model can never be overwritten by something other than another GCM block. Overwriting a resource model layer with an ore control model results in a more accurate representation of the portion of mine site.

The regions of interest in the process 200, e.g., the first blasting location 502, etc., may be selected by based on nodes in the bounding volume hierarchy (BVH) nodes using a conversion engine.

The topographies may be obtained using LIDAR scanning.

In order to generate the in-situ positions of the material in subprocess 212, the BVH nodes are associated/linked with excavation destinations using fleet data or dig line data to determine the destinations for the BVH nodes.

Updating the 3D model using the second, third topographies 802,1202, etc., includes determining from the BVH nodes which of the BVH nodes are above the second, third topographies, etc.

The process 200 is effectively iterated for each blast.

It is not necessary to encode a region of interest into two or more BVH nodes using a conversion engine if it is intended that the region of interest be subject to further blasting. As would be appreciated, there is no limit on how many times a region of interest may be blasted.

By updating the 3D model in time regularly, such as before and after each subsequent blast, a user may select an area of interest and a date range of interest, and the process can apply the merged insituized topographies in the date range to the resource model and compare against known deliveries to plant and other destinations to yield direct F3 reconciliation.

To track the location and history of all the material that exists after a blast, information specific to the material of interest needs to be insituized. As would be reasonably understood, only the selected portion (or area) of interest rather than the entire mine site needs to be insituized.

The 3D model may be divided into voxels of a selected volume, e.g., 1 m×1 m×1 m, and tagged so that every voxel that is below the last topography is filled with the most appropriate representation such as, for example, insituized, post-blast, or void. However, it would be appreciated that the voxels are freely sized and do not strictly have to be divided into voxels of 1 m×1 m×1 m so that the particles moved during a movement simulation action on a model in time, are perfectly representative of the 3D model. Voxels deemed to be too big may be subdivided. Each voxel may be assigned attributes which may include, for example, the material type and/or material grade, e.g., based on the ore control/resource data. Once every voxel has been tagged, all material above the new topography is marked as mined, or partially mined. All voxels which contain material marked as mined, or partially mined, are insituized by the insituizing engine.

The insituizing engine functions by enabling samples to interact with the appropriate 3D model. Once the 3D model in time is generated, the system 100 can determine the appropriate date for a point sample and automatically select the appropriate version/update of the 3D model to insituize this to.

For example, when a new topography is brought into the system, all material above this topography is marked as ‘mined’ and an insituized topography will be created at this date. An insituized topography is created by the following subprocesses:
a. generating the 3D model such that every voxel that is below the last topography is filled with the most appropriate representation (i.e., insituized, post-blast, or void)—although each voxel will generally have dimensions of 1 m×1 m×1m, it would be appreciated that voxels are freely sized and may be subdivided if deemed too large;
b. all material above the new topography is marked as mined—as the voxels are freely sized, it is possible for blocks to be partially mined;
c. all blocks tagged as mined are insituized by the insituizing engine as follows by:
   i. post-blast blocks are composed of percentages of pre-blast model blocks (sometimes up to 6 pre-blast block partials can be present in a post-blast block), so these are summed up, and the subprocess creates a set of voxel size blocks, with their proportional destination based on the destination that the post-blast model was assigned at the time of mining, and
   ii. all in-situ blocks are summed together, and insituized in their current location—this ensures that material volumes which may have been removed and are unaccounted for are appropriately marked as ‘unknown’ in the insituized topography; and
d. as all of the voxels are insituized, the destination makeup of each of these voxels can be better understood/measured—although the voxels are freely sized, and may be assigned to proportionally to any number of destinations, they must still add up to 100% of the available overall area.

In short, the insituizing engine enables multiple blocks to be simultaneously tracked such that the appropriate calculations can be processed as quickly as possible. This allows the destination makeup of each of these insituized block, and ensures that every single block is accounted for.

So that the voxels or locations in the post-blast model can be connected to locations in the pre-blast model (i.e., “insituizing” the post-blast locations), the 3D model (also referred to herein as the “model in time”) includes several layers that are representative of the portion of the mine site over a period of time. Each layer may include a volumetric model of the portion of the mine site at a snapshot in time.

The topography data may be collected by using known techniques, e.g., laser scanning, by collecting measurements using a drone, or any other appropriate technique as long as these techniques have an accuracy/resolution of less than 30 cm.

The models used for each layer preferably adhere to geostatistics best practice, e.g., the models are combined together in a geostatistically sound way which means no reblocking.

To generate the model in time, each layer is consolidated and merged such that newer models overwrite older models in volume to create the best possible representation of volume in each of the layers. Individual layers may be ranked by the quality of the data such as GCM>Reserve Model>Resource Model etc. A resource model may be created by mine geologists from geochemical sampling of the ground, and represents a long term view of the ore body. An ore control model is similar to the resource model, except that it is constructed from information that can only be generated shortly before material is mined.

The layers are then overlaid upon each other to create the model in time. Layers that are considered to be a more accurate representation of the mine at a point in time overwrite layers that are less accurate. For example, a resource model layer is considered to be less accurate than ore control as there is an assumption that the ore control model is a better representation of a volume than the resource model. Thus, where both an ore control model and resource model layer exist, the resource model is overwritten even if the Resource Model is more recent. An ore control model can never be overwritten by something other than another GCM block To create the best possible representation of volume, each individual layer may be constructed by aggregating the blocks volumetrically with blocks that are in newer models overwriting the equivalent blocks in older models. If a perfect overlap cannot be obtained, the blocks may be split such that there are no holes or averaging that would damage the model.

The model in time enables material involved in a blast to be tracked. As the model in time is representative of the mine over a period of time, it is possible to utilize a model of the mine after a site has been blasted, and create a geometric reconstruction of material in pre-blast space. However, all of the blocks in the model in time should be freely sized such that no blocks are ever averaged together. This enables the system to dynamically slice all of the blocks in the model in time so that each data point is absolutely representative of the information fed into the system.

As all the material involved in a blast is tracked in the model in time, it is impossible for the in-situ models which have had their blasted materials removed (pre blast cuts) to overlap any material from the post blast model. Thus, all the material that exists after a blast can be reconciled to their respective pre-blast location.

The memory 108, and/or external memory that is accessible by the CPU 106 and/or GPU 104 via the network interface 110, comprises computer-readable media with machine-readable instructions that, when executed by the CPU 106 and/or the GPU 104, cause the CPU 106 and/or the GPU 104 to perform the process 200.

### Interpretation

The presence of “/” in a FIG. or text herein is understood to mean “and/or” unless otherwise indicated, i.e., “A/B” is understood to mean “A” or “B” or “A and B”.

The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” or “substantially” can indicate a percentage greater than or equal to 50%, 60%, 70%, 80%, or 90%, for instance, 92.5%, 95%, 97.5%, 99%, or 100%.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Many modifications will be apparent to those skilled in the art without departing from the scope of the present invention.

1-15. (canceled)

16. A process for tracking material dislodged during blasting of a portion of a mine site, the process comprising:
encoding a portion of a mine site into two or more bounding volume hierarchy (BVH) nodes using a conversion engine;
receiving a first topography of the portion of the mine site after at least one blast;
after at least partial excavation of the blasted material, marking the BVH nodes according to associated excavation destinations using fleet data, dig line data, or both to determine the destinations for the BVH nodes;
receiving a second topography of the portion of the mine site after the partial excavation of the blasted material, and determining from the BVH nodes which of the BVH nodes are above the second topography;
determining in-situ positions of the BVH nodes based on received movement vectors for the at least one blast;
receiving an in-situ pre-blast topography model; and
using the conversion engine and a Constructive Solid Geometry (CSG) process to tag excavation destinations and digging dates from the BVH nodes in the in-situ pre-blast topography model.

17. The process according to claim 16, wherein the in-situ pre-blast topography model is a model in time.

18. The process according to claim 17, wherein the conversion engine is a bounding volume hierarchy Constructive Solid Geometry (CSG) Engine.

19. The process according to claim 18, wherein the topography is obtained from LIDAR scanning.

20. The process according to claim 19, wherein the in-situ position of the BVH nodes is determined before the at least one blast.

21. The process according to claim 20, further comprising:
receiving a user input from a user to select, from the tagged in-situ topography model, an area of interest and a date range of interest;
applying merged insituized topographies in the date range to a resource model; and
comparing against known deliveries to excavation destinations to generate a measurement of direct F3 reconciliation.

22. The process according to claim 21, wherein the model is divided into voxels, optionally wherein the voxels have a selected volume.

23. (canceled)

24. The process according to claim 16, further comprising:
obtaining two or more volumetric models of the portion of the mine site over a period of time, wherein the period of time encompasses a period during which the portion of the mine site is in operation, including at least a first point in time before the at least one blast and a second point in time after the at least one blast; and
generating a 3D model by overlaying and merging the two or more volumetric models, wherein the 3D model is representative of the portion of the mine site over the period of time.

25. The process according to claim 24, wherein the two or more volumetric models include: in-situ pre-blast topography model, and the first topography.

26. The process according to claim 25, wherein the two or more volumetric models further include the second topography.

27-29. (canceled)

30. The process according to claim 16, wherein the conversion engine is a bounding volume hierarchy Constructive Solid Geometry (CSG) Engine.

31. The process according to claim 16, wherein the topography is obtained from LIDAR scanning.

32. The process according to claim 16, wherein the in-situ position of the BVH nodes is determined before the at least one blast.

33. The process according to claim 16, further comprising:
receiving a user input from a user to select, from the tagged in-situ topography model, an area of interest and a date range of interest;
applying merged insituized topographies in the date range to a resource model; and
comparing against known deliveries to excavation destinations to generate a measurement of direct F3 reconciliation.

34. The process according to claim 16, wherein the model is divided into voxels, optionally wherein the voxels have a selected volume.

35. A system for tracking material dislodged during blasting of a portion of a mine site, the system including a computing system with a central processing unit (CPU), a graphics processing unit (GPU), or both, configured to perform the process according to claim 16.

36. A computer-readable medium including machine-readable instructions that, when executed by a central processing unit (CPU), a graphics processing unit (GPU), or both, cause the CPU, the GPU, or both, to perform the process according to claim 1.
